(19) United States
(12) Patent Application Publication
(10) Pub. No.: US 2012/0236180 A1
(43) Pub. Date: Sep. 20, 2012

(54) IMAGE ADJUSTMENT METHOD AND ELECTRONICS SYSTEM USING THE SAME

(76) Inventor: Zhao-Yuan LIN, New Taipei City (TW)

(21) Appl. No.: 13/338,802

(22) Filed: Dec. 28, 2011

(30) Foreign Application Priority Data
Mar. 15, 2011 (TW) 100108681

(51) Int. Cl. G06K 9/46; H04N 5/262

(52) U.S. Cl. 348/239; 382/195; 348/E05.051

(57) ABSTRACT

An image adjustment method is provided in the invention. The image adjustment method has the following steps: receiving at least one first image in front of a display captured by a camera device, wherein the display has a screen center; detecting the first image to generate a facial image, wherein the facial image has a face position and a face center; capturing a second image with the face center from the facial image according to the face position; shifting the second image to overlap the face center with the screen center to generate a third image; and scaling the third image to generate an output image in accordance with a predetermined resolution.

### CROSS REFERENCE TO RELATED APPLICATIONS

This application claims priority of Taiwan Patent Application No. 100108681, filed on Mar. 15, 2011, the entirety of which is incorporated by reference herein.

### BACKGROUND OF THE INVENTION

1. Field of the Invention

The present invention relates to image adjustment, and in particular relates to electronics systems and methods thereof for image adjustment by recognizing human faces.

2. Description of the Related Art

A digital remote controller plays an important role in controlling TV channels, and the digital remote controller includes functions such as switching channel, adjusting sound, and adjusting picture, functions and etc. As the development of image processing technologies for face recognition and hand detection improves, a convenient way can be achieved to remotely control the aforementioned functions by gestures with detection of positions of the face and hands of a user. Conventional methods for detecting faces and gestures embed a plurality of user interfaces (UI) on the TV screen, and the user may activate the desired function, modifying the volume of sounds and settings for the pictures by a simple gesture. However, if the user is located away from the center line of the TV screen or at an inappropriate distance and the camera only has a fixed prime lens, it will make the user interfaces become unusable and cause inconvenience to the user. Therefore, an image adjustment method is highly demanded to resolve the issue that the user is not located at an appropriate position.

### BRIEF SUMMARY OF THE INVENTION

A detailed description is given in the following embodiments with reference to the accompanying drawings.

In an embodiment, an electronics system is provided. The electronics system comprises: a display, having a screen center; a camera device, for capturing at least one first image in front of the display; a face detection unit, for detecting the first image to generate a facial image, wherein the facial image has a face position and a face center; and an image adjustment device, for capturing a second image containing the face center from the facial image according to the face position, shifting the second image to overlap the face center with the screen center to generate a third image, and scaling the third image to generate an output image in accordance with a predetermined resolution.

In another embodiment, an image adjustment method is provided. The method comprises: receiving at least one first image in front of a display captured by a camera device, wherein the display has a screen center; detecting the first image to generate a facial image, wherein the facial image has a face position and a face center; capturing a second image with the face center from the facial image according to the face position; shifting the second image to overlap the face center with the screen center to generate a third image; and scaling the third image to generate an output image in accordance with a predetermined resolution.

In yet another embodiment, a computer program product for loading into a machine to execute a method for an image adjustment method is provided. The computer program product comprises: a first program code for receiving at least one first image in front of a display captured by a camera device, wherein the display has a screen center; a second program code for detecting the first image to generate a facial image, wherein the facial image has a face position and a face center; a third program code for capturing a second image with the face center from the facial image according to the face position; a fourth program code for shifting the second image to overlap the face center with the screen center to generate a third image; and a fifth program code for scaling the third image to generate an output image in accordance with a predetermined resolution.

### BRIEF DESCRIPTION OF THE DRAWINGS

The present invention can be more fully understood by reading the subsequent detailed description and examples with references made to the accompanying drawings, wherein:

FIG. 1A illustrates a block diagram of an electronics system according to an embodiment of the invention;

FIG. 1B illustrates a block diagram of an image adjustment device according to an embodiment of the invention.

FIG. 2 illustrates a flow chart of an image adjustment method according to another embodiment of the invention.

FIGS. 3A and 3B illustrate a diagram for capturing matching images and shifting/scaling processing to the matching images according to another embodiment of the invention.

FIG. 4A illustrates a diagram for hand detection according to an embodiment of the invention.

FIG. 4B illustrates a diagram for event detection according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

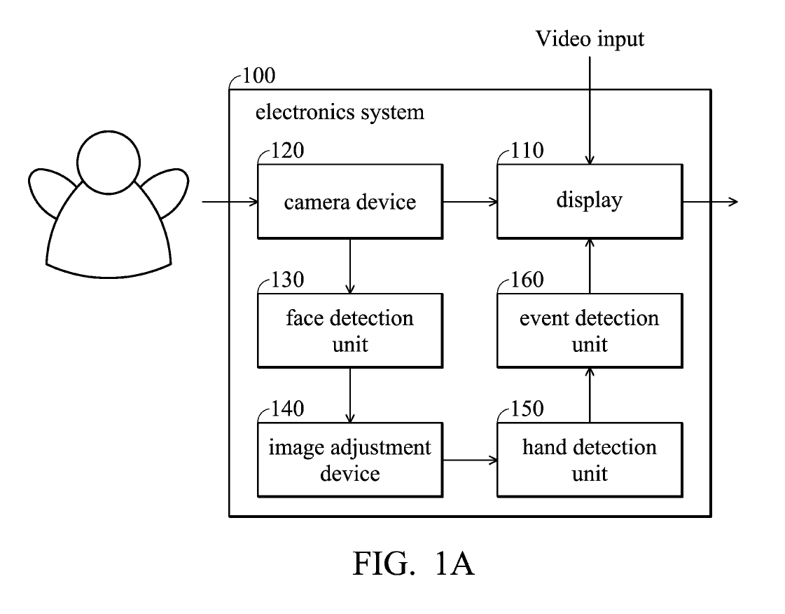

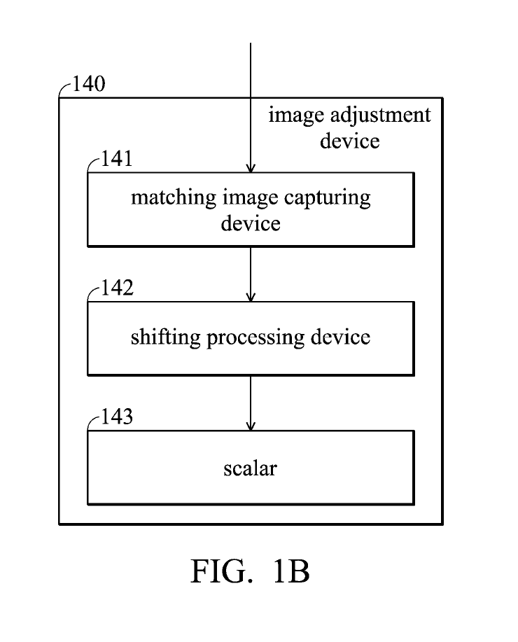

FIG. 1A illustrates a block diagram of an electronics system 100 according to an embodiment of the invention. The electronic system 100 comprises a display 110, a camera device 120, a face detection unit 130, an image adjustment device 140, a hand detection unit 150, and an event detection unit 160. The display 110 displays video input signals from different sources, such as TV programs, pictures captured by the camera device 120 and/or output images processed by the image adjustment device 140. The camera device 120 is used to capture a plurality of first images in front of the display 110. The camera device 120 can be cameras, web cameras or other camera devices, but the invention is not limited thereto. The face detection unit 130 is electrically connected to the camera device 120, for receiving the plurality of first images captured by the camera device 120, and detecting a facial image from the plurality of first images.

In an embodiment, the face detection unit 130, the image adjustment device 140 and the hand detection unit 150 automatically start after the electronics system 100 boots up, and these devices keep detecting whether any gesture in the plurality of first images is a fast movement for more than a predetermined period (e.g. 1 second), wherein corresponding user interfaces are displayed on the display 110 after detecting a facial image and a position of the hand, and an event detection unit 160 is triggered. If the user moves a hand out of the range of the display 110, the user interface will be closed, and the face detection unit 130, the image adjustment device 140 and the hand detection unit 150 will go back to the procedure for detecting movements of the hand.

In another embodiment, when the user waves a hand quickly for more than the predetermined time (e.g. 1 second), the face detection unit 130 is activated to prevent unnecessary activation due to slight movement of the hand of the user. In also another embodiment, the camera device 120 is a camera with a fixed prime lens, and photographing is restricted for the face detection unit 130 to detect faces. For example, the bias angle toward the X axis, Y axis and Z axis is between −30 degrees to 30 degrees, and the distance between the user and the camera device 120 is between about 1.5 m to 5 m, but the invention is not limited thereto.

In another embodiment, the face detection unit 130 uses the OpenCV library to detect faces. The OpenCV library uses the algorithm “AdaBoost Learning with Haar-like Features” published by Viola and Jones to detect faces. The face detection unit 130 may further mark a red ellipse window on the detected facial images, but the invention is not limited thereto.

The image adjustment device 140 is electrically connected to the face detection unit 130, for receiving the facial images detected by the face detection unit 130, and performing the image adjustment procedure. FIG. 1B illustrates a block diagram of an image adjustment device 140 according to an embodiment of the invention. In an embodiment, as illustrated in FIG. 1B, the image adjustment device 140 further comprises a matching image capturing device 141, a shifting processing device 142, and a scalar 143. The matching image capturing device 141 receives the facial image detected by the face detection unit 130 to calculate the height and width of the face, and the facial image has a face center. In a better embodiment, according to the face detected, the matching image capturing device 141 extends 1.5 times that of the height of the face from the face center in both up and down directions (vertical directions), and extends 2 times that of the width of the face from the face center in both left and right direction (horizontal directions), to capture a second image, but the invention is not limited thereto. In another embodiment, if the aspect ratio of the first image captured by the camera device 120 is 4:3 and the aspect ratio of the display 110 is also 4:3, the second image captured by the matching image capturing device 141 is an image with 1.5 times that of the height of the face vertically extended from the face center and 2 times that of the width of the width of the face horizontally extended from the face center, thereby the second image is an image with a 4:3 aspect ratio. The matching image capturing device 141 can further adjust the range of the height and width of the face for follow-up scaling processing according to the aspect ratio of the first image and the display 110 to prevent from aspect ratio distortion of the image.

The shifting processing device 142 receives the second image captured by the matching image capturing device 141, and shifts the face center of the second image to overlap with the screen center of the display 110. For example, if the upper-leftmost point of the screen of the display 110 is the origin, which has positive values horizontally toward the right direction, and positive values vertically toward the down direction, where W is the horizontal resolution of the display 110, H is the vertical resolution of the display 110, Px is the coordinate in the horizontal direction (X-axis) of the center of the ellipse face window, and Py is the coordinate in the vertical direction (Y-axis) of the center of the ellipse face window. The shifting processing device 142 can calculate the required vector M for shifting the face center to the screen center of the display 110, and the vector M can be expressed as the following equation:

M=(W/2−Px,H/2−Py).

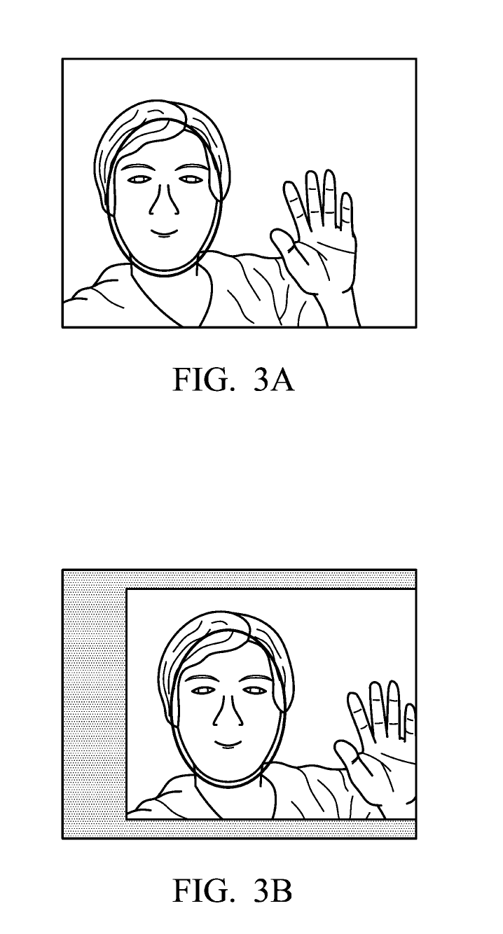

The second image is shifted to the center of the display 110 to generate a third image. In an embodiment, the third image generated by the shifting processing device 142 can not fill the full screen of the display 110, and the shifting processing device 142 will fill the remaining part of the screen other than the third image with black color. For the screen of the display 110, the third image can be regarded as a valid image region, as illustrated in FIG. 3B, and the third image can be obtained after capturing matching images and shifting the first image.

The scalar 143 receives the third image generated by the shifting processing device 142, and performs scaling to the third image. As described in the aforementioned embodiments, for example, if the distance between the user and the camera device 120 is between 1.5 m and 5 m, only enlargement for the third image is considered. If V is the height of the third image and P is the vertical resolution of the display 110, the aspect ratio S=P/V is used in the scalar 143 to enlarge the third image to generate an output image with an aspect ratio identical to that of the resolution of the display 110. It should be noted that the aspect ratio of the third image is identical to that of the screen of the display 110, and thus the aspect ratio of the output image is also identical to that of the screen of the display 110, but the invention is not limited thereto. In one embodiment, for example, if the camera device 120 is a web camera with a resolution of 320×240, the size of the face can be defined to between 70 to 90 pixels. If the number of pixels of the face is out of the range, the scalar 143 can perform corresponding enlargement/shrinking processes. In another embodiment, the distance between the user and the camera device may be very short, or the resolution of the camera device 120 may be larger than that of the display 110, thus, the scalar 143 would have to perform shrinking possesses to the third image to make the output images be in accordance with the resolution of the display 110. If V is the height of the third image and P is the vertical resolution of the display 110, the scalar 143 shrinks the third images with the ratio S=P/V. If insufficient information of the user can not be obtained due to the short distance between the user and the camera device 120, it is not necessary to shrink the third images. In also another embodiment, the scalar 143 can scale the third images to fit a predetermined resolution. For example, the predetermined resolution can be the resolution of the display 110 or a resolution with a restricted image region, and the aspect ratio of the output images after scaling is identical to that of the second images to prevent distortion of the output images, but the invention is not limited thereto.

In another embodiment, the order between the shifting processing device 142 and the scalar 143 in the image adjustment device can be exchanged. That is, the second image can be shifted to generate the third image and the third image would be scaled to generate the output images, as well as the second image can be scaled to generate the third image and the third image would be shifted to generate the output images. It should be noted that, if the second image is scaled first, there may be some shifting between the face center of the generated third image and that of the facial image, however, the screen center of the display 110 is constant. For example, if the upper-leftmost point of the screen of the display 110 is the origin with positive values horizontally toward the right direction, and positive values vertically toward the down direction, where W is the horizontal resolution of the display 110, H is the vertical resolution of the display 110, Px is the coordinate in the horizontal direction (X-axis) of the center of the ellipse face window, and Py is the coordinate in the vertical direction (Y-axis) of the center of the ellipse face window. The shifting processing device 142 can calculate the required vector M′ for shifting the face center to the coordinate (W/2, H/2) of the screen center of the display 110, and the vector M′ can be expressed as the following equation:

M′=(W/2−Px′,H/2−Py′).

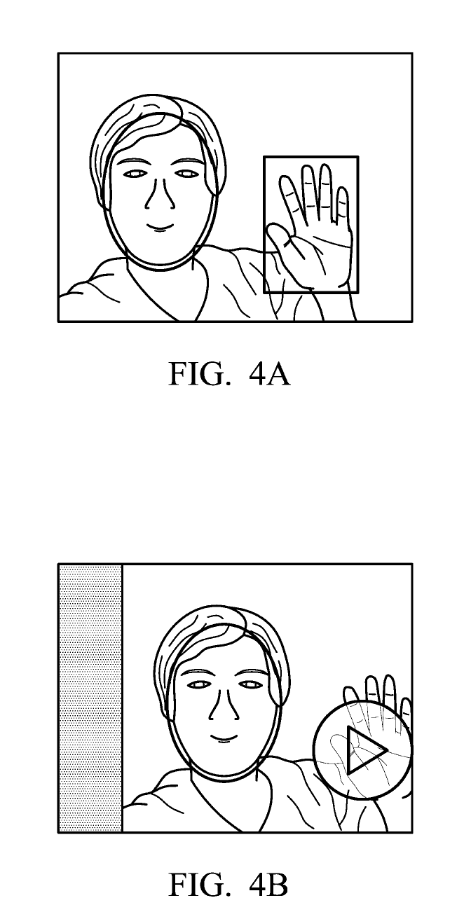

The hand detection unit 150 detects the position of the hand in the output images generated by the scalar 143. For example, the object detection method provided by Viola and Jones can be applied in the invention to alternate the training samples to detect the hand and corresponding gestures. However, the feature points of the hand are not so many as those of the face, and the object detect method provided by Viola and Jones with skin color detection is used in the invention to provide more accurate hand detection results. In an embodiment, the hand detection unit 150 can further display a user interface, wherein a position of the user interface matches the detected hand position. For example, as illustrated in FIG. 4A, the hand detection unit 150 marks a green window around the hand position of the output image, so that a user can observe the variations in the hand position on the display 110, but the invention is not limited thereto.

The event detection unit 160 detects gestures on the hand position in the output images. A user can use different gestures to control the user interface, such as activating a graphics button or activating corresponding events to complete remote control by gestures. As illustrated in FIG. 4B, the user can manipulate the graphics button by variations of gestures.

In an embodiment, the image adjustment device 140 can further transform the output image to a transparent image, which is displayed on the display 110. When a user controls the user interface with gestures, it can prevent TV programs on the display 110 to be completely covered by the output image.

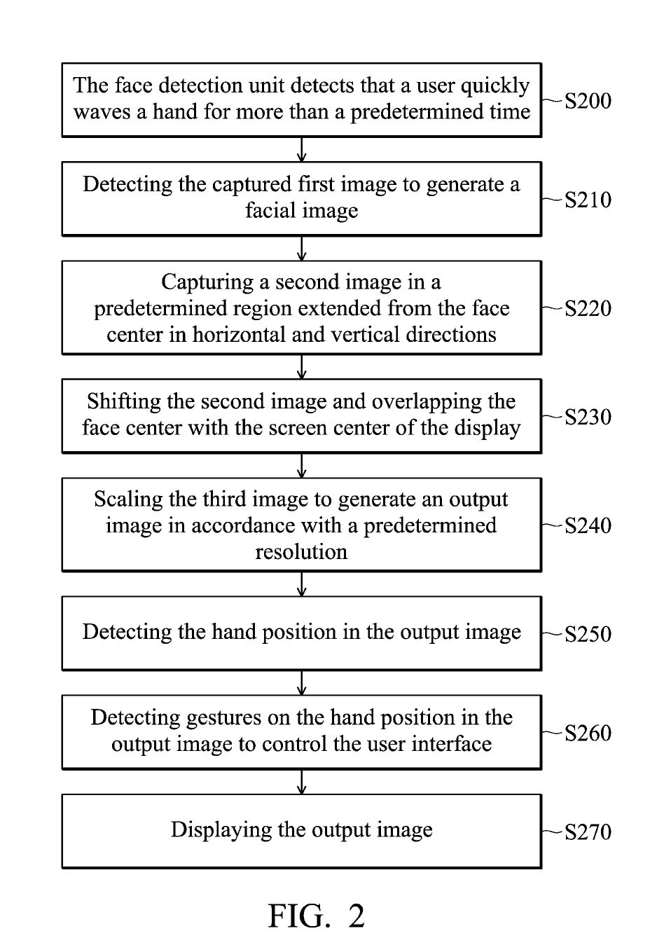

FIG. 2 illustrates a flow chart of an image adjustment method according to an embodiment of the invention. In step S200, the user quickly waves his hand for more than the predetermined period (e.g. 1 second) to activate the face detection unit 130. In step S210, the face detection unit 130 generates a facial image by detecting the face in the first image captured by the camera device 120. In step S220, the matching image capturing device 141 captures a second image within a predetermined region in a horizontal direction and vertical direction from the face center of the facial image. In step S230, the shifting processing device 142 shifts the second image to generate a third image, so that a face center of the facial image overlaps with the screen center of the display 110. In step S240, the scalar 143 scales the third image to generate an output image in accordance with a predetermined resolution. In step S250, the hand detection unit 150 detects the hand position in the output image. In step S260, the event detection unit 160 detects the gestures on the hand position in the output image to control the user interface. In step S270, the output image is displayed on the display 110. The detailed description of steps S200 to S270 in FIG. 2 are identical to the description of various devices in FIG. 1A and FIG. 1B, and it will not be described here again.

In the invention, a lost cost camera with a fixed prime lens can be used. The image adjustment method provided in the invention can adjust the captured facial image to the center of the display, so that a user can easily control the user interface. After detecting a hand position and the gestures in the facial image, the user may also control a TV by gestures.

The image adjustment system and method, or certain aspects or portions thereof, may take the form of program code embodied in tangible media, such as floppy diskettes, CD-ROMs, hard drives, or any other machine-readable (e.g., computer-readable) storage medium, or computer program products without limitation in external shape or form thereof, wherein, when the program code is loaded into and executed by a machine, such as a computer, the machine thereby becomes an apparatus for practicing the methods. The present invention also provides A computer program product for being loaded into a machine to execute a method for an image adjustment method, comprising: a first program code for receiving at least one first image in front of a display captured by a camera device, wherein the display has a screen center; a second program code for detecting the first image to generate a facial image, wherein the facial image has a face position and a face center; a third program code for capturing a second image with the face center from the facial image according to the face position; a fourth program code for shifting the second image to overlap the face center with the screen center to generate a third image; and a fifth program code for scaling the third image to generate an output image in accordance with a predetermined resolution.

The methods may also be embodied in the form of program code transmitted over some transmission medium, such as an electrical wire or a cable, or through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An electronics system, comprising
a display, having a screen center;
a camera device, for capturing at least one first image in front of the display;
a face detection unit, for detecting the first image to generate a facial image, wherein the facial image has a face position and a face center; and
an image adjustment device, for capturing a second image containing the face center from the facial image according to the face position, shifting the second image to overlap the face center with the screen center to generate a third image, and scaling the third image to generate an output image in accordance with a predetermined resolution.

2. The electronics system as claimed in claim 1, wherein the camera captures the first image with a fixed prime lens.

3. The electronics system as claimed in claim 1, wherein when a user waves a hand for more than one second, the face detection unit performs face detection to the first image to generate the facial image.

4. The electronics system as claimed in claim 1, wherein the face detection unit further marks a first window on a face position in the facial image.

5. The electronics system as claimed in claim 1, wherein the face detection captures the second image from the facial image by extending a first multiple from the face center in horizontal directions and a second multiple from the face center in vertical directions.

6. The electronics system as claimed in claim 1, wherein the image adjustment device further transforms the output image to a transparent image, which is displayed on the display.

7. The electronics system as claimed in claim 1, further comprising a hand detection unit, for detecting a hand position in the output image.

8. The electronics system as claimed in claim 7, wherein the hand detection unit further makes a position of a user interface match the hand position in the output image.

9. The electronics system as claimed in claim 8, wherein the hand detection unit further displays a second window on the hand position in the output image.

10. The electronics system as claimed in claim 9, further comprising an event detection unit, for detecting a plurality of gestures from the hand position to control the user interface.

11. The electronics system as claimed in claim 1, wherein an aspect ratio of the output image is identical to an aspect ratio of the second image.

12. An image adjustment method, comprising:
receiving at least one first image in front of a display captured by a camera device, wherein the display has a screen center;
detecting the first image to generate a facial image, wherein the facial image has a face position and a face center;
capturing a second image with the face center from the facial image according to the face position;
shifting the second image to overlap the face center with the screen center to generate a third image; and
scaling the third image to generate an output image in accordance with a predetermined resolution.

13. The image adjustment method as claimed in claim 12, further comprising: detecting the first image to generate the facial image when a user quickly waves a hand for more than one second.

14. The image adjustment method as claimed in claim 12, wherein the second image is captured by extending a first multiple in horizontal directions and a second multiple in vertical directions from the face center.

15. The image adjustment method as claimed in claim 12, further comprising: transforming the output image to a transparent image which is displayed on the display.

16. The image adjustment method as claimed in claim 12, further comprising: detecting a hand position in the output image.

17. The image adjustment method as claimed in claim 16, further comprising: displaying a user interface, wherein a position of the user interface matches the hand position in the output image.

18. The image adjustment method as claimed in claim 17, further comprising: detecting a plurality of gestures from the hand position to control the user interface.

19. The image adjustment method as claimed in claim 12, wherein an aspect ratio of the output image is identical to an aspect ratio of the second image.

20. A computer program product for being loaded into a machine to execute a method for an image adjustment method, comprising:
a first program code for receiving at least one first image in front of a display captured by a camera device, wherein the display has a screen center;
a second program code for detecting the first image to generate a facial image, wherein the facial image has a face position and a face center;
a third program code for capturing a second image with the face center from the facial image according to the face position;
a fourth program code for shifting the second image to overlap the face center with the screen center to generate a third image; and
a fifth program code for scaling the third image to generate an output image in accordance with a predetermined resolution.
